(19) United States
(12) Patent Application Publication
(10) Pub. No.: US 2025/0094625 A1
(43) Pub. Date: Mar. 20, 2025

(54) SECURE EDUCATIONAL TRANSCRIPT ACCESS VIA AN ONLINE EXTENSION

(71) Applicant: Skillco LLC, Pleasant Grove, UT (US)

(72) Inventors: Stephen Matthew Lockhart, Pleasant Grove, UT (US); Jackson Christiansen Lohman, Orem, UT (US)

(21) Appl. No.: 18/468,429

(22) Filed: Sep. 15, 2023

(51) Int. Cl. G06F 21/62

(52) U.S. Cl. CPC G06F 21/6245

(57) ABSTRACT

Disclosed embodiments are directed to systems and methods to provide recommendations based on an educational transcript. Embodiments receive a request from a user to synchronize an educational transcript and determine a URL (uniform resource locator) associated with the educational transcript. Embodiments automatically open the URL in the web browser and download a set of data specifying a set of completed educational courses from the URL. Embodiments send the set of data to a server computing system. Embodiments receive the set of data at the server computing system from the extension and parse the set of completed educational courses from the set of data. Embodiments map the set of completed educational courses to a set of skills and provide a recommendation based on mapping the set of completed educational courses to the set of skills.

### BACKGROUND

As a current or former student, giving access to an educational transcript to a third party is often restricted by security measures (e.g., technology and policy). While these security measures may protect private information, in some instances, a student may want to give access to their transcript to a third party to get insights on their academic career or future careers. This requires the student to request the transcript from the school or access it locally and send it to a third party. However, security measures associated with educational transcripts make the student go through a multi-step process to retrieve their educational transcript and send them to a third party.

The subject matter claimed herein is not limited to embodiments that solve any disadvantages or that operate only in environments such as those described supra. Instead, this background is only provided to illustrate one example technology area where some embodiments described herein may be practiced.

### SUMMARY

In some aspects, the techniques described herein relate to systems, methods, and computer program products for a client computing system, which includes a first processor system and a first computer-readable storage medium, including first computer-executable instructions that are executable by the first processor system to implement an extension in a web browser, the extension configured to: receive a request from a user to synchronize an educational transcript; determine a URL (uniform resource locator) associated with the educational transcript; automatically open the URL in the web browser; download a set of data from the URL, the set of data specifying a set of completed educational courses; and send the set of data to a server computing system. In some aspects, the techniques described herein also relate to systems, methods, and computer program products for a server computing system, which includes a second processor system and a second computer-readable storage medium, including second computer-executable instructions that are executable by the second processor system to at least: receive the set of data from the extension; parse a set of completed educational courses from the set of data; map the set of courses to a set of skills; and provide a recommendation based on mapping the set of courses to the set of skills.

In some aspects, the techniques described herein relate to systems, methods, and computer program products for a server computing system, in which the server computing system receives a set of data from an extension operating in a web browser at a client computing system. The extension receives a request from a user to synchronize an educational transcript, determines a URL associated with the educational transcript, automatically opens the URL in the web browser, downloads a set of data from the URL, the set of data specifying a set of completed educational courses, and sends the set of data to the server computing system. The server computing system parses a set of completed educational courses from the set of data, maps the set of courses to a set of skills, and provides a recommendation based on mapping the set of courses to the set of skills.

In some aspects, the techniques described herein relate to systems, methods, and computer program products in which an extension in a web browser on a client computing system: receives a request from a user to synchronize an educational transcript; determines a URL associated with the educational transcript; automatically opens the URL in the web browser; downloads a set of data from the URL, the set of data specifying a set of completed educational courses; and sends the set of data to a server computing system. In some aspects, the techniques described herein also relate to systems, methods, and computer program products in which the server computing system: receives the set of data from the extension, parses a set of completed educational courses from the set of data, maps the set of courses to a set of skills, and provides a recommendation based on mapping the set of courses to the set of skills.

This Summary introduces a selection of concepts in a simplified form that are further described below in the Detailed Description. This Summary is not intended to identify key features or essential features of the claimed subject matter, nor is it intended to be used to determine the scope of the claimed subject matter.

### BRIEF DESCRIPTION OF THE DRAWINGS

To describe how the advantages of the systems and methods described herein can be obtained, a more particular description of the embodiments briefly described supra is rendered by reference to specific embodiments thereof, which are illustrated in the appended drawings. These drawings depict only typical embodiments of the systems and methods described herein and are not, therefore, to be considered to be limiting in their scope. Systems and methods are described and explained with additional specificity and detail through the use of the accompanying drawings, in which:

FIGS. 1A and 1B illustrate an example of a computer architecture that facilitates providing a recommendation based on an educational transcript accessed by a web browser extension.

FIGS. 2A and 2B illustrate an example of a web browser extension receiving an educational transcript.

FIG. 3 illustrates an example of a server creating recommendations based on the educational transcript.

FIGS. 4A and 4B illustrate examples of skills mapping based on an educational transcript.

FIG. 5 illustrates a flow chart of an example of a method for a web browser extension to access and send an educational transcript.

FIG. 6 illustrates a flow chart of an example of a method for a server to receive an educational transcript and provide a recommendation.

### DETAILED DESCRIPTION

Currently, a user has two ways of accessing their educational transcript. First, the user logs into an academic institution's website or goes to the academic institution and receives a copy of their educational transcript. Second, the user may submit a request to the educational institution for the educational institution to send their educational transcript to a third party. Due to confidentiality and the FERPA (Family Educational Rights and Privacy Act), educational institutions cannot give academic information to third parties without direct and explicit authorization from the user. While these regulations keep educational information associated with the user in the control of the user, it causes extra hoops to jump through when the user wants to use their educational transcript and particularly when the user wants to share their educational transcript with a third party.

At least some embodiments described herein provide a way for a user to request to synchronize an educational transcript using a web-browser-implemented extension and receive recommendations based on the educational transcript without requesting official transcripts from the educational institution or having to download the transcript on a personal computer and send it to a third party. In at least some embodiments, the extension is configured to download information from a URL (uniform resource locator) associated with the educational transcript and send the data to a server. The server is configured to parse and map the data contained within the educational transcript in order to provide a recommendation to the user regarding the educational transcript.

At least some embodiments are particularly advantageous by allowing the user to receive career, course, or skill recommendations from a third party based on their educational transcript without going through a multi-step process to access their educational transcript and share the educational transcript with the third party. Another advantage of at least some embodiments is that the user maintains control of access to their educational transcripts. Some embodiments are further advantageous by giving recommendations to a user to help the user reach academic, skills, and/or career goals based on information the user may not have immediate access to. The recommendations provided by embodiments are efficient, easily accessible, and updated when the educational transcript changes, therefore, allowing the user to receive updated recommendations as the user progresses through their academic career.

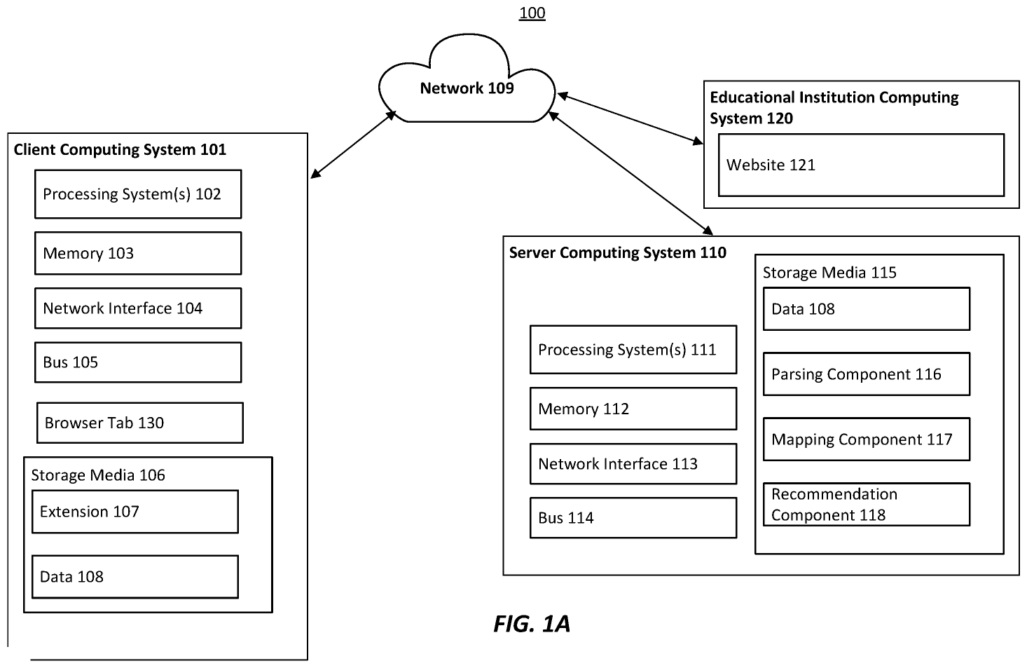

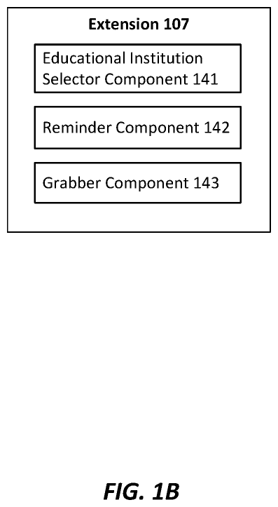

FIG. 1A illustrates an example of computer architecture 100 that facilitates a web browser extension and a server working together to receive educational transcripts and provide recommendations to a user. As shown, computer architecture 100 includes a client computing system 101 comprising a processor system 102 (e.g., a single processor or a plurality of processors), a memory 103 (e.g., system or main memory), a storage media 106 (e.g., a single computer-readable storage medium, or a plurality of computer-readable storage media), and a network interface 104 (e.g., one or more network interface cards), all interconnected by a bus 105. As shown, network interface 104 is operable for interconnecting client computing system 101 to, e.g., a server computing system 110 and an educational institution computing system 120 (via a network 109).

As also shown in FIG. 1A, server computing system 110 comprises a processor system 111 (e.g., a single processor or a plurality of processors), a memory 112 (e.g., system or main memory), a storage media 115 (e.g., a single computer-readable storage medium, or a plurality of computer-readable storage media), and a network interface 113 (e.g., one or more network interface cards), all interconnected by a bus 114. As shown, network interface 113 is operable for interconnecting server computing system 110 to client computing system 101.

FIG. 1A illustrates storage media 106 of client computing system 101 as storing computer-executable instructions (e.g., an extension 107) that are executable by a processor (e.g., processor system 102) to cause a computer system (e.g., client computing system 101) to download a set of data 108 comprising an educational transcript from the server computing system 110.

In embodiments, extension 107 operates within a web browser executing on client computing system 101. In embodiments, extension 107 receives a request from a user to synchronize an educational transcript. In some embodiments, the user may initiate the request by interacting with extension 107 (e.g., by selecting an icon presented by extension 107). In some embodiments, a request may automatically be sent to extension 107 from a browser tab 130 when the user opens a URL associated with an educational institution within the web browser where extension 107 operates (e.g., a URL associated with a website 121 of educational institution computing system 120 shown on the browser tab 130 of the client computing system 101). In yet other embodiments, extension 107 may pop up on a displayed user interface, where the user can manually make a request. In some embodiments, the request may include information such as login information, an email address, a degree related to the educational transcript, an institution associated with the educational transcript, or a combination.

In embodiments, extension 107 determines a URL associated with the requested educational transcript. Extension 107 may determine the URL as being the URL the web browser currently has opened, a URL associated with the educational institution in the request, or the URL associated with the educational institution that is associated with the email address in the request.

In embodiments, extension 107 automatically opens the URL in the web browser that was previously determined. In some embodiments, the user may be asked to log in to a webpage located at the URL associated with the educational transcript. In other embodiments, extension 107 may have login credentials from the user that are previously saved or inputted at extension 107 during the request.

Once the educational transcript is available from the URL, embodiments download, by extension 107, a set of data 108 from the URL. In embodiments, the set of data 108 is specified within one or more computer-readable formats, such as HTML (hypertext markup language), PDF (portable document format), XML (extensible markup language), JSON (JavaScript object notation), CSV (comma-separated values), unformatted text, and the like. In other embodiments, the set of data 108 is extracted from the URL by extension 107 by converting images to text from content on the URL. In yet other embodiments, the set of data 108 is downloaded from the URL using other appropriate techniques.

The set of data 108 specifies a set of completed educational courses. In some embodiments, the set of data 108 may specify other information about the set of completed educational courses. For example, in embodiments, the set of data 108 may include a set of grades, a set of professors, a set of semesters, a set of course descriptions, a set of course skills, a set of course information, or other information related to the set of completed educational courses in the set of data 108.

In some embodiments, extension 107 downloads all information from the URL, including header information and other information unrelated to the completed educational courses (e.g., HTML markup, XML tags, and the like). In some embodiments, extension 107 only downloads the information related to the completed educational courses.

In embodiments, extension 107 sends the set of data 108 to server computing system 110. In some embodiments, extension 107 sends the set of data 108 to server computing system 110 via network 109.

Regarding server computing system 110, FIG. 1A illustrates storage media 115 as storing computer-executable instructions (e.g., parsing component 116, mapping component 117, and recommendation component 118) that are executable by a processor (e.g., processor system 111) to cause a computer system (e.g., server computing system 110) to provide a recommendation to the user based on the set of data 108 from the educational transcript.

In embodiments, server computing system 110 receives the set of data 108 from extension 107 and saves the set of data 108 in storage media 115. In embodiments, parsing component 116 parses the set of completed educational courses from the set of data 108. In some embodiments, parsing component 116 may also parse other information from the set of data 108. For example, parsing component 116 may parse a set of grades, a set of professors, a set of semesters, a set of course descriptions, or other information related to the set of completed courses.

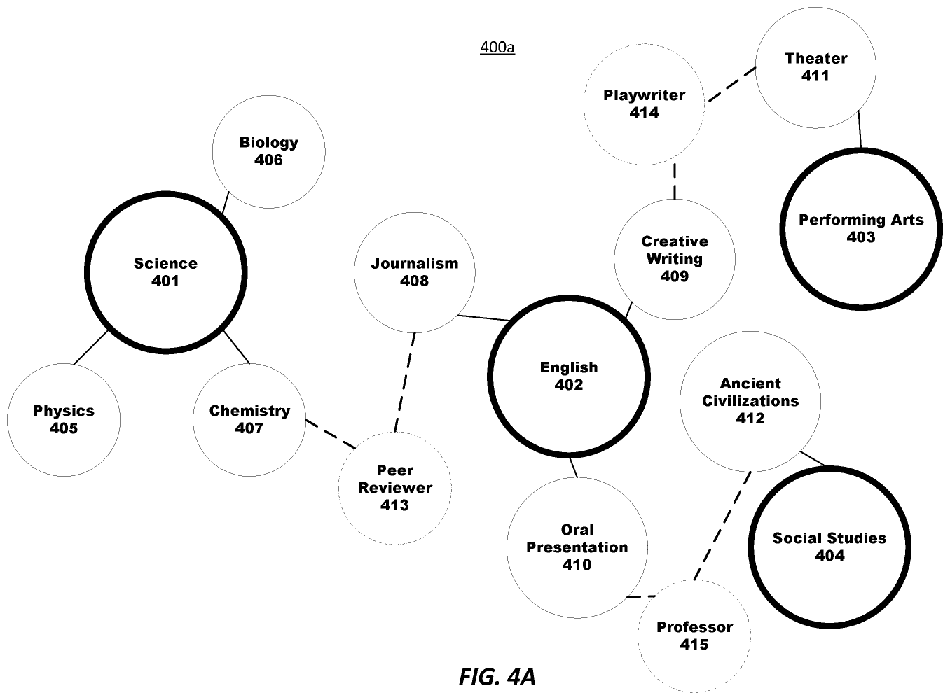

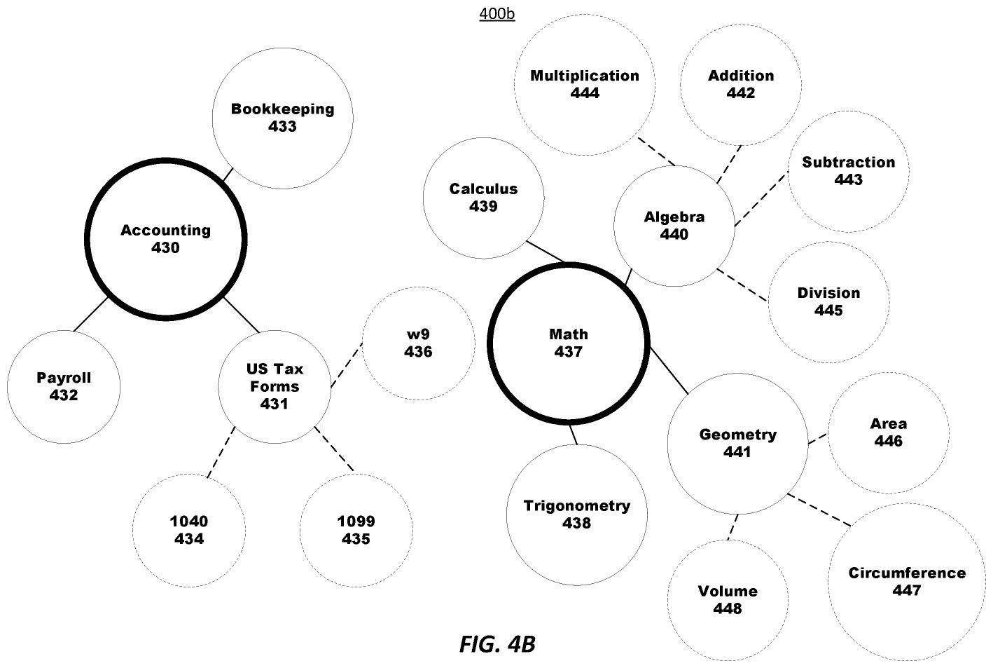

In embodiments, mapping component 117 maps the set of completed educational courses to a set of skills. In some embodiments, the set of skills is located in a database (e.g., at server computing system 110) and can be manually updated. In yet other embodiments, the set of skills is updated by an artificial intelligence/machine learning model. In other embodiments, the set of skills may be determined from a set of course descriptions or a set of course objectives found in the set of data 108. In some embodiments, the set of skills is dynamically or automatically updated. In some embodiments, mapping component 117 further creates a visual representation of a course, skills, and career map, shown in FIG. 4, described in more detail below.

In embodiments, recommendation component 118 provides a recommendation to the user based on the mapping between the set of completed educational courses to the set of skills. In some embodiments, the recommendation includes a set of recommended future courses based on the set of completed courses. For example, if one of the completed courses was Writing I, recommendation component 118 might recommend the user take Writing II. In some embodiments, the recommendation includes a set of recommended careers. For example, if the set of completed courses included Biology, Chemistry, and Teaching, recommendation component 118 may recommend that the user become a high school science teacher. In some embodiments, the recommendation includes a set of recommended skills. For example, if the set of completed courses includes journalism and biology, recommendation component 118 may recommend the peer review editing skills.

In some embodiments, recommendation component 118 provides a recommendation that considers other information from the set of data 108. For example, if a user has failed a completed course, recommendation component 118 may recommend the user re-take the course. In some embodiments, the user may select a particular career the user is interested in. In this embodiment, recommendation component 118 may consider courses and skills required for the particular career. In this case, recommendation component 118 may recommend future courses and future skills based on the user-selected career.

FIG. 1B illustrates additional details regarding the extension 107. In more detail, the extension 107 includes an educational institution selector component 141, a reminder component 142, and a grabber component 143. In some embodiments, the educational institution selector component 141 is used to select the correct educational institution, described in more detail below. In embodiments, the reminder component 142 may be used to remind the user of deadlines associated with the educational institution. For example, in some embodiments the reminder component 142 may remind the user of add/drop deadlines, the start of the semester, the end of the semester, when grades are released, or other updates associated with the educational institution. In embodiments, the grabber component 143 may be used to grab the information from the educational transcript, described in more detail below. For example, the grabber component 143 may grab the HTML code from the website 121.

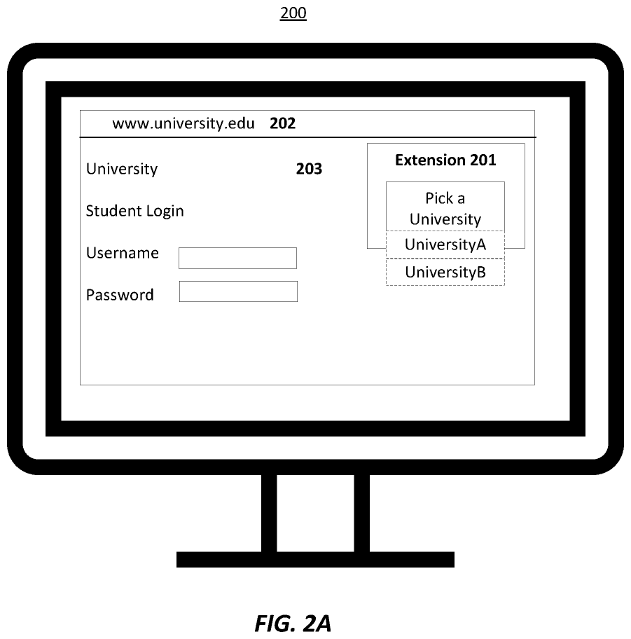

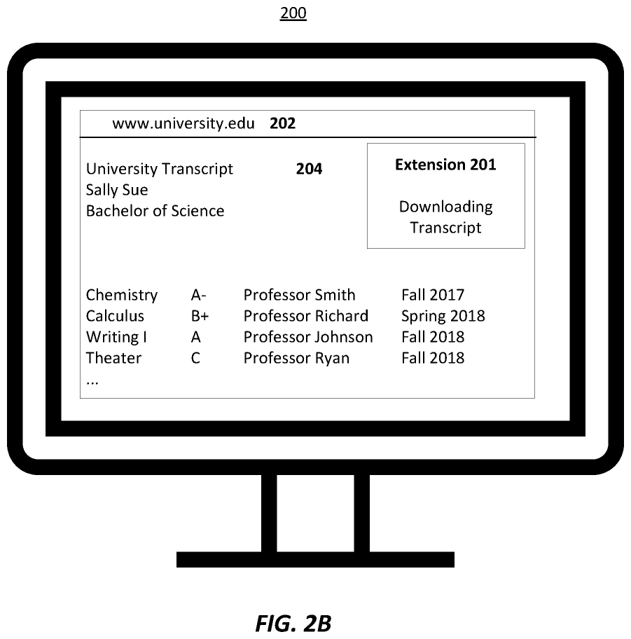

FIGS. 2A and 2B illustrate an example of a client computing system 200, such as client computing system 101 in FIG. 1A. In FIG. 2A, the client computing system 200 has a URL 202 (e.g., associated with website 121) opened within a web browser. FIG. 2A illustrates a webpage 203, comprising various information. Client computing system 200 also shows an example user interface of an extension 201.

As shown in FIG. 2A, extension 201 may present a pop-up box on the web browser. In this example, extension 201 presents a drop-down menu to pick a university showing University A and University B as an option. In some embodiments, the extension 201 may present a button for the user to request an educational transcript. The user may push the request transcript button in extension 201, and extension 201 determines URL 202. In this example, extension 201 determines URL 202 to be an identified URL currently opened in the web browser. As shown in FIG. 2A, the user may be prompted to log in to webpage 203 associated with the educational institution.

Turning to FIG. 2B, once the user logs in to the educational institute's website (e.g., website 121), the web browser loads the educational transcript information 204. This allows extension 201 to obtain the educational transcript information 204. The educational transcript information 204 may be a set of data 108 specified within HTML, JSON, XML, etc., obtained from URL 202. In this example, extension 201 downloads the set of data 108 that specifies completed educational courses (e.g., Chemistry, Calculus, Writing I, and Theater). Extension 201 may also download other data associated with the completed educational courses, such as grades, professors, and semesters during which the course was taken. Additionally, in some embodiments, extension 201 downloads information not relating to the completed educational courses, such as the school, name of the user, and degree title. Extension 201 sends the set of data 108 to server computing system 110.

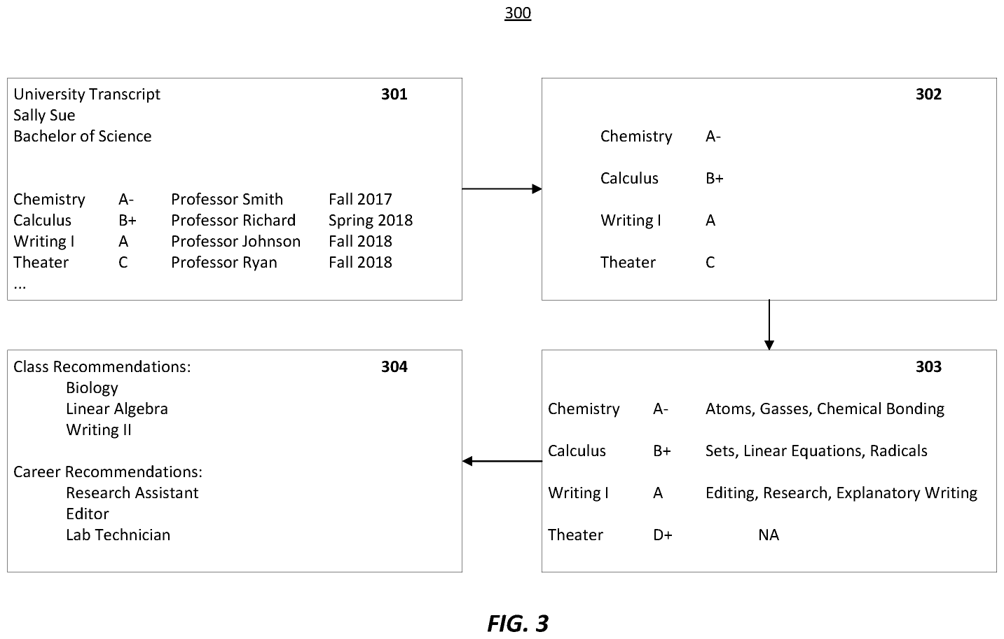

Turning to FIG. 3, FIG. 3 illustrates an example of a server computing system 300 (e.g., the server computing system 110). As shown in FIG. 3, embodiments receive a set of data 301 (e.g., set of data 108) from extension 201. Parsing component 116 parses the set of completed educational courses from the set of data 301. As also shown, in this example embodiment, parsing component 116 also parses a set of grades associated with the set of completed educational courses from the set of data 301.

In embodiments, mapping component 117 maps the set of completed educational courses and grades 302 to a set of skills 303. In this example, Chemistry is mapped to Atoms, Gasses, and Chemical Bonding, Calculus is mapped to Sets, Linear Equations, and Radicals, and Writing I is mapped to Editing, Research, and Explanatory Writing. As shown in this example, in some embodiments, if a certain grade is below a specified grade (e.g., a grade of a “D+” in Theater), the completed educational course may not be mapped to a skill. In other embodiments, all completed educational courses may be mapped to skills. In other embodiments, the specified grade threshold may be higher or lower. In yet other embodiments, mapping component 117 may consider other information in the mapping process.

In embodiments, recommendation component 118 provides a recommendation 304 based on mapping the set of completed educational courses to the set of skills 303. As shown in this example embodiment, recommendation component 118 provides a class recommendation (e.g., Biology, Linear Algebra, and Writing II) and a career recommendation (e.g., Research Assistant, Editor, Lab Technician) based on the mapping. In some embodiments, the course recommendations may include courses that are similar to completed education courses (e.g., Chemistry and Biology) or courses that are progressive (e.g., Writing I and Writing II). In some embodiments, the career recommendations may consider the completed educational courses and the set of skills (e.g., Science and Research Assistant) to make recommendations of appropriate careers. In some embodiments, recommendation 304 may further include recommended skills.

FIG. 4A illustrates an example of a map 400a created by mapping component 117, which may optionally be presented to the user. As shown in map 400a, broad subjects are in bold (e.g., Science 401, English 402, Performing Arts 403, and Social Studies 404). In this example, the completed educational courses are shown in non-bold and include Physics 405, Biology 406, Chemistry 407, Journalism 408, Creative Writing 409, Oral Presentation 410, Theater 411, and Ancient Civilizations 412. Some embodiments enable the user to interact with map 400a. In these embodiments, the user may click or hover over a course (e.g., Biology 406) and see more information regarding the completed education course (e.g., a grade, a professor, a semester). Additionally, the user may see skills associated with the completed educational courses, such as Science, when interacting with Chemistry 407.

Embodiments map the skills and completed educational courses with mapping component 117 to provide recommendations. The recommendations are shown dotted in FIG. 4A (e.g., Peer Reviewer 413, Playwriter 414, and Professor 415). In some embodiments, the user may interact with the recommendations to see future course recommendations or future skills required or preferred for the career (e.g., a professor may need an advanced degree).

In some embodiments, map 400a only includes completed educational courses and current recommendations. In other embodiments, map 400a may include all possible completed courses, all possible skills, and all possible recommendations. In these embodiments, the user may interact with map 400a to decide on a specific career (e.g., Peer Reviewer 413) and get recommendations on courses and skills required or preferred for that career.

FIG. 4B illustrates an alternative example of a map 400b created by mapping component 117, which may optionally be presented to the user. As shown in map 400b, broad subjects are in bold (e.g., Accounting 430 and Math 437). In this example, the broad courses are mapped to specific courses. For example, Accounting 430 is mapped to Bookkeeping 433, Payroll 432, and US Tax Forms 431 while Math 437 is mapped to Calculus 439, Algebra 440, Geometry 441, and Trigonometry 438. The specific courses can further be mapped to specific skills. For example, US Tax Forms 431 is mapped to skills 1040 434, 1099 435, and w9 436, Algebra 440 is mapped to Multiplication 444, Addition 442, Subtraction 443, and Division 445, and Geometry 441 is mapped to Area 446, Volume 448, and Circumference 447.

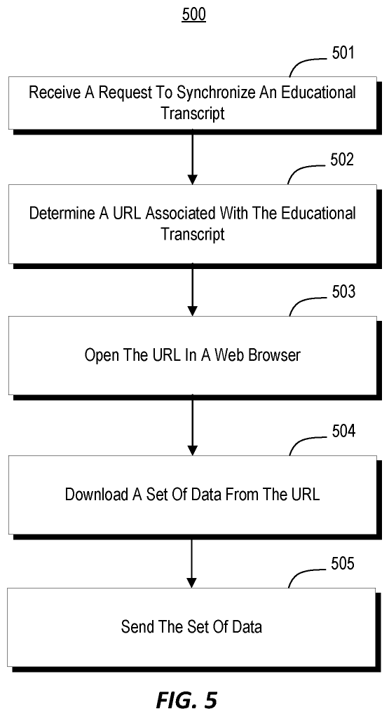

Embodiments are now described in connection with FIG. 5, which illustrates a flow chart of an example method 500 for downloading a set of data from a URL by extension 107. In embodiments, instructions for implementing method 500 are encoded as computer-executable instructions (e.g., extension 107) stored on a computer storage media (e.g., storage media 106) that are executable by a processor (e.g., processor system 102) to cause a computer system (e.g., client computing system 101) to perform method 500. The following discussion now refers to a number of methods and method acts. Although the method acts are discussed in specific orders or are illustrated in a flow chart as occurring in a particular order, no order is required unless expressly stated or required because an act is dependent on another act being completed prior to the act being performed.

Referring to FIG. 5, in embodiments, method 500 comprises acts to receive data from an educational transcript by extension 107. Referring to act 501, extension 107 receives a request to synchronize an educational transcript. In embodiments, extension 107 runs in a web browser on client computing system 101. The user may request to synchronize the educational transcript by pushing an icon on the web browser connected to extension 107 or by pushing a button in extension 107. In some embodiments, the user may automatically request the educational transcript by extension 107 by visiting an educational website on the web browser. In some embodiments, the request may include a school name and an educational degree. In some embodiments, the request may include an email address associated with an educational institution.

Referring to act 502, extension 107 determines a URL associated with the educational transcript. In some embodiments, the URL may be the URL the web browser currently has loaded. In some embodiments, the URL may be associated with the URL of the educational institution in the request by the user. In some embodiments, the URL may be associated with the email address provided by the user in the request.

In some embodiments, act 501 comprises receiving a request from a user to synchronize an educational transcript, and act 502 comprises determining a URL associated with the educational transcript.

Referring to act 503, extension 107 opens the URL in the web browser on client computing system 101. In some embodiments, the URL may already be opened in the web browser. In some embodiments, the URL is automatically opened in the web browser. In some embodiments, extension 107 may prompt the user to approve opening the web browser (e.g., a re-direct link, a permission pop-up, or a message indicating a new window is being opened). In some embodiments, the user is prompted to log in to the URL opened by the browser. In these embodiments, the user may receive a prompt by extension 107 or the URL opened in the web browser. In some embodiments, extension 107 may automatically log the user into a webpage located at the URL opened in the web browser.

Referring to act 504, extension 107 downloads a set of data 108 from the URL. In embodiments, the set of data 108 is specified in HTML, PDF, XML, JSON, CSV, unformatted text, or the like. In other embodiments, the set of data 108 may be recognized using image-to-text technology (e.g., optical character recognition). The set of data 108 downloaded by extension 107 specifies a set of completed educational courses. In some embodiments, the set of data 108 may further specify additional information associated with the completed education courses. For example, the set of data 108 may include a grade, a professor, a semester, a course description, and a set of credits (e.g., the number of credits received for each educational course in the set of completed educational courses). In some embodiments, the set of data 108 may further include information about non-completed educational courses such as dropped or withdrawn educational courses or educational courses audited. In some embodiments, the set of completed educational courses may only include educational courses where the user received credit for the educational courses, or in other words, removes failed or incomplete educational courses.

Referring to act 505, extension 107 sends the set of data 108 to server computing system 110. In some embodiments, extension 107 stores the set of data 108 in storage media 106, and client computing system 101 sends the set of data 108 to server computing system 110 via network 109. Server computing system 110 stores the set of data 108 in storage media 115.

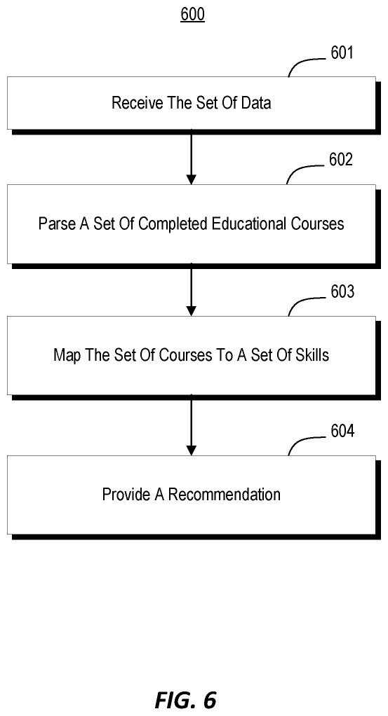

Embodiments are now described in connection with FIG. 6, which illustrates a flow chart of an example method 600 for providing a recommendation by a server computing system 110. In embodiments, instructions for implementing method 600 are encoded as computer-executable instructions (e.g., parsing component 116, mapping component 117, and recommendation component 118) stored on a computer storage media (e.g., storage media 115) that are executable by a processor (e.g., processor system 111) to cause a computer system (e.g., server computing system 110) to perform method 600. The following discussion now refers to a number of methods and method acts. Although the method acts are discussed in specific orders or are illustrated in a flow chart as occurring in a particular order, no order is required unless expressly stated or required because an act is dependent on another act being completed prior to the act being performed.

Referring to FIG. 6, in embodiments, method 600 receives data from an educational transcript by extension 107 and provides a recommendation. Referring to act 601, server computing system 110 receives the set of data 108 from extension 107 on the client computing system 101. The set of data 108 specifies a set of completed educational courses. Additionally, in some embodiments, the set of data 108 may include information associated with the set of completed educational courses. For example, the data may include a grade for each completed course, a professor for each completed course, a semester or term the completed course was taken, and course descriptions of the completed courses. In some embodiments, the data may further include data specifying educational courses currently in progress or educational courses that were not completed (e.g., withdrawn or dropped). In some embodiments, the data may only include completed educational courses where the user received a passing grade.

Referring to act 602, parsing component 116 parses a set of completed educational courses from the set of data 108. In some embodiments, parsing component 116 parses the completed educational courses and the grades associated with the completed educational courses. In some embodiments, parsing component 116 may parse more information from the set of data 108, such as professors who taught the completed courses or a semester the completed course was taken.

In some embodiments, act 601 comprises receiving a set of data 108 from extension 107 operating in a web browser at client computing system 101, and act 602 comprises parsing the set of completed educational courses from the set of data 108.

Referring to act 603, mapping component 117 maps the set of completed educational courses to a set of skills (e.g., a skills map). In some embodiments, the skills come from a database stored by server computing system 110, and the skills are updated manually or dynamically. In some embodiments, the skills are found in the set of data 108, such as course descriptions, course goals, or other information describing the educational courses. In this case, parsing component 116 may further parse the set of skills from the set of data 108. In some embodiments, the mapping considers information in the data, such as a grade associated with each completed course. For example, if a user received a low passing grade in one course and a high passing grade in another course, the mapping may weigh the skills associated with the course with the high passing grade more than the skills associated with the course with the low passing grade.

In some embodiments, the mapping of the set of completed educational courses and the set of skills is illustrated in map 400, as shown in FIG. 4. The created map can be visualized by the user as a spider-web-like map highlighting the correlation between completed educational courses and the set of skills and, optionally, careers related to the completed educational courses and skills.

Referring to act 604, recommendation component 118 provides a recommendation based on mapping the set of completed educational courses to the set of skills. The recommendation may include a set of recommended future courses, a set of recommended careers, or a set of recommended skills. In some embodiments, the recommendation may include a combination of the above-mentioned recommendations. In some embodiments, the recommendation may consider other information found in the set of data 108. For example, if a user has failed an educational course, the recommendation may include re-taking the failed course or no longer taking courses in that field of study.

In some embodiments, act 603 comprises mapping the set of completed educational courses to a set of skills, and act 604 comprises providing a recommendation based on mapping the set of completed educational courses to the set of skills.

Embodiments of the disclosure comprise or utilize a special-purpose or general-purpose computer system (e.g., client computing system 101 and server computing system 110) that includes computer hardware, such as, for example, a processor system (e.g., processor system 102 and processor system 111) and system memory (e.g., memory 103 and memory 112), as discussed in greater detail below. Embodiments within the scope of the present disclosure also include physical and other computer-readable media for carrying or storing computer-executable instructions and/or data structures. Such computer-readable media can be any available media accessible by a general-purpose or special-purpose computer system. Computer-readable media that store computer-executable instructions and/or data structures are computer storage media (e.g., storage media 106 and storage media 115). Computer-readable media that carry computer-executable instructions and/or data structures are transmission media. Thus, embodiments of the disclosure can comprise at least two distinctly different kinds of computer-readable media: computer storage media and transmission media.

Computer storage media are physical storage media that store computer-executable instructions and/or data structures. Physical storage media include computer hardware, such as random access memory (RAM), read-only memory (ROM), electrically erasable programmable ROM (EEPROM), solid state drives (SSDs), flash memory, phase-change memory (PCM), optical disk storage, magnetic disk storage or other magnetic storage devices, or any other hardware storage device(s) which store program code in the form of computer-executable instructions or data structures, which can be accessed and executed by a general-purpose or special-purpose computer system to implement the disclosed functionality.

Transmission media include a network and/or data links that carry program code in the form of computer-executable instructions or data structures that are accessible by a general-purpose or special-purpose computer system. A “network” is defined as a data link that enables the transport of electronic data between computer systems and other electronic devices. When information is transferred or provided over a network or another communications connection (either hardwired, wireless, or a combination thereof) to a computer system, the computer system may view the connection as transmission media. The scope of computer-readable media includes combinations thereof.

Upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., network interface 104 and network interface 113) and eventually transferred to computer system RAM and/or less volatile computer storage media at a computer system. Thus, computer storage media can be included in computer system components that also utilize transmission media.

Computer-executable instructions comprise, for example, instructions and data which, when executed at a processor system, cause a general-purpose computer system, a special-purpose computer system, or a special-purpose processing device to perform a function or group of functions. In embodiments, computer-executable instructions comprise binaries, intermediate format instructions (e.g., assembly language), or source code. In embodiments, a processor system comprises one or more central processing units (CPUs), one or more graphics processing units (GPUs), one or more neural processing units (NPUs), and the like.

In some embodiments, the disclosed systems and methods are practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. In some embodiments, the disclosed systems and methods are practiced in distributed system environments where different computer systems, which are linked through a network (e.g., by hardwired data links, wireless data links, or by a combination of hardwired and wireless data links), both perform tasks. As such, in a distributed system environment, a computer system may include a plurality of constituent computer systems. Program modules may be located in local and remote memory storage devices in a distributed system environment.

In some embodiments, the disclosed systems and methods are practiced in a cloud computing environment. In some embodiments, cloud computing environments are distributed, although this is not required. When distributed, cloud computing environments may be distributed internally within an organization and/or have components possessed across multiple organizations. In this description and the following claims, “cloud computing” is a model for enabling on-demand network access to a shared pool of configurable computing resources (e.g., networks, servers, storage, applications, and services). A cloud computing model can be composed of various characteristics, such as on-demand self-service, broad network access, resource pooling, rapid elasticity, measured service, and so forth. A cloud computing model may also come in the form of various service models such as Software as a Service (Saas), Platform as a Service (PaaS), Infrastructure as a Service (IaaS), etc. The cloud computing model may also be deployed using different deployment models such as private cloud, community cloud, public cloud, hybrid cloud, etc.

Some embodiments, such as a cloud computing environment, comprise a system with one or more hosts capable of running one or more virtual machines (VMs). During operation, VMs emulate an operational computing system, supporting an operating system (OS) and perhaps one or more other applications. In some embodiments, each host includes a hypervisor that emulates virtual resources for the VMs using physical resources that are abstracted from the view of the VMs. The hypervisor also provides proper isolation between the VMs. Thus, from the perspective of any given VM, the hypervisor provides the illusion that the VM is interfacing with a physical resource, even though the VM only interfaces with the appearance (e.g., a virtual resource) of a physical resource. Examples of physical resources include processing capacity, memory, disk space, network bandwidth, media drives, and so forth.

Although the subject matter has been described in language specific to structural features and/or methodological acts, it is to be understood that the subject matter defined in the appended claims is not necessarily limited to the described features or acts described supra or the order of the acts described supra. Rather, the described features and acts are disclosed as example forms of implementing the claims.

The present disclosure may be embodied in other specific forms without departing from its essential characteristics. The described embodiments are only as illustrative and not restrictive. All changes which come within the meaning and range of equivalency of the claims are to be embraced within their scope.

When introducing elements in the appended claims, the articles “a,” “an,” “the,” and “said” are intended to mean there are one or more of the elements. The terms “comprising,” “including,” and “having” are intended to be inclusive and mean that there may be additional elements other than the listed elements. Unless otherwise specified, the terms “set,” “superset,” and “subset” are intended to exclude an empty set, and thus “set” is defined as a non-empty set, “superset” is defined as a non-empty superset, and “subset” is defined as a non-empty subset. Unless otherwise specified, the term “subset” excludes the entirety of its superset (i.e., the superset contains at least one item not included in the subset). Unless otherwise specified, a “superset” can include at least one additional element, and a “subset” can exclude at least one element.

What is claimed:

1. A system comprising:
a client computing system comprising a first processor system and a first computer-readable storage medium comprising first computer-executable instructions that are executable by the first processor system to implement an extension in a web browser, the extension configured to:
receive a request from a user to synchronize an educational transcript;
determine a URL (uniform resource locator) associated with the educational transcript;
automatically open the URL in the web browser;
download a set of data from the URL, the set of data specifying a set of completed educational courses; and
send the set of data to a server computing system; and
the server computing system, which comprises a second processor system and a second computer-readable storage medium comprising second computer-executable instructions that are executable by the second processor system to at least:
receive the set of data from the extension;
parse the set of completed educational courses from the set of data;
map the set of completed educational courses to a set of skills; and
provide a recommendation based on mapping the set of completed educational courses to the set of skills.

2. The system of claim 1, wherein the set of data includes a set of grades, wherein each grade in the set of grades is associated with a course within the set of completed educational courses.

3. The system of claim 2, wherein mapping the set of completed educational courses to the set of skills is based on the set of grades.

4. The system of claim 1, wherein the set of data is specified using one or more of,
HTML (hypertext markup language),
PDF (portable document format),
XML (extensible markup language),
JSON (JavaScript object notation),
CSV (comma-separated values), or
unformatted text.

5. The system of claim 1, wherein the recommendation includes at least one of,
a set of recommended future courses,
a set of recommended careers, or
a set of recommended skills.

6. The system of claim 1, wherein the client computing system logs into a webpage located at the URL with a login associated with the user and the educational transcript.

7. The system of claim 1, wherein the set of data includes at least one of,
a set of professors,
a set of semesters, or
a set of credits.

8. The system of claim 1, wherein the URL is determined by,
an identified URL currently opened in the web browser, or
an email address associated with the user.

9. A method, implemented in a server computing system, comprising:
receiving a set of data from an extension operating in a web browser at a client computing system, wherein the extension:
receives a request from a user to synchronize an educational transcript,
determines a URL (uniform resource locator) associated with the educational transcript,
automatically opens the URL in the web browser,
downloads the set of data from the URL, the set of data specifying a set of completed educational courses, and
sends the set of data to the server computing system;
parsing the set of completed educational courses from the set of data;
mapping the set of completed educational courses to a set of skills; and
providing a recommendation based on mapping the set of completed educational courses to the set of skills.

10. The method of claim 9, wherein the set of data further includes a set of grades, wherein each grade in the set of grades is associated with a course within the set of completed educational courses.

11. The method of claim 10, wherein the method further comprises parsing the set of grades from the set of data.

12. The method of claim 11, wherein mapping the set of completed educational courses to the set of skills is based on the set of grades.

13. The method of claim 9, wherein the method further comprises creating a skills map of the set of completed educational courses and the set of skills.

14. The method of claim 13, wherein the user is enabled to interact with the skills map.

15. The method of claim 9, wherein the recommendation includes at least one of,
a set of recommended future courses,
a set of recommended careers, or
or a set of recommended skills.

16. A method, implemented in an extension in a web browser on a client computing system, comprising:
receiving a request from a user to synchronize an educational transcript;
determining a URL (uniform resource locator) associated with the educational transcript;
automatically opening the URL in the web browser;
downloading a set of data from the URL, the set of data specifying a set of completed educational courses; and
sending the set of data to a server computing system, wherein the server computing system:
receives the set of data from the extension,
parses the set of completed educational courses from the set of data,
maps the set of completed educational courses to a set of skills, and
provides a recommendation based on mapping the set of completed educational courses to the set of skills.

17. The method of claim 16, wherein the URL is determined by,
an identified URL currently opened in the web browser, or
an email address associated with the user.

18. The method of claim 16, wherein the set of data further includes a set of grades, wherein each grade in the set of grades is associated with a course within the set of completed educational courses.

19. The method of claim 16, wherein the set of data further includes at least one of a set of professors, a set of semesters, or a set of credits.

20. The method of claim 16, wherein the method further comprises logging into a webpage located at the URL with a login associated with the user and the educational transcript.
